(19) United States
(12) Patent Application Publication
(10) Pub. No.: US 2025/0017200 A1
(43) Pub. Date: Jan. 16, 2025

(54) DITHIOCARBAMATE FUNGICIDE COMBINATIONS AND COMPOSITIONS THEREOF

(71) Applicant: ADAMA MAKHTESHIM LTD., Beer Sheva (IL)

(72) Inventors: Sugata ROY, Burdwan (IN); Ivan GORLOVETSKY, Beer Sheva (IL)

(73) Assignee: ADAMA MAKHTESHIM LTD., Beer Sheva (IL)

(21) Appl. No.: 18/709,409

(22) PCT Filed: Nov. 11, 2022
(86) PCT No.: PCT/IL2022/051206

§ 371 Date: May 10, 2024

(30) Foreign Application Priority Data
Nov. 12, 2021 (IN) 202111052034

(51) Int. Cl. A01N 25/04; A01N 25/30; A01N 47/14; A01N 57/20; A01P 3/00; A01P 13/00

(52) U.S. Cl. CPC A01N 25/04; A01N 25/30; A01N 47/14; A01N 57/20; A01P 3/00; A01P 13/00

(57) ABSTRACT

The present invention relates to stable combined dispersions of at least one dithiocarbamate fungicide and at least one acid-based pesticide, and/or derivative thereof in a liquid carrier, wherein said dispersion is stabilized by inclusion of at least one organic phosphoric acid ester-based compatibility agent and wherein said dispersion is characterized by an improvement in the stability, compatibility, and suspensibility of the dispersion defined by a reduction in the rate and/or extent of phase separation and/or sedimentation. The invention further relates to methods for preparing and using said combined dispersions and methods for identifying useful organic phosphoric acid ester-based compatibility agents.

### RELATED APPLICATION/S

This application claims benefits of Indian Provisional Application No. 202111052034 filed on Nov. 12, 2021; the entire content of which is hereby incorporated by reference herein.

Throughout this application various publications are referenced. The disclosures of these documents in their entireties are hereby incorporated by reference into this application in order to more fully describe the state of the art to which this invention pertains.

### FIELD

The present invention relates to combination of (1) dithiocarbamate fungicide, (2) acid-based pesticide, (3) phosphoric acid ester-based compatibility agent exemplified by alkyl polyalkylene glycol ether phosphoric acid ester acid form and (4) water. The invention further relates to methods for preparing and using said combination.

### INTRODUCTION

Combination of at least two different pesticides for controlling different pests or for improving treatment such as achieving a synergistic effect are well known practices in the agricultural field. Mancozeb, a multi-site contact fungicide with a broad spectrum and a pesticide especially in salt form such as glyphosate potassium and/or glufosinate-potassium are not compatible in the presence of water. Stability of the suspension comprising mancozeb and the pesticide in its salt form is rapidly reduced and phase separation and/or sedimentation occurs. There is a need to develop a method for combining mancozeb with pesticide in salt form exemplified by glyphosate and glufosinate.

### SUMMARY OF THE INVENTION

The present invention provides a stable combined dispersion of at least one dithiocarbamate fungicide and at least one acid-based pesticide or derivative thereof, and/or derivative thereof in a liquid carrier, wherein said dispersion is stabilized by inclusion of at least one organic phosphoric acid ester-based compatibility agent and wherein said dispersion is characterized by an improvement in the stability, compatibility, and suspensibility of the dispersion defined by either or both, (a) a reduction in the rate and/or extent of phase separation and/or sedimentation as compared with a combined dispersion of the same amount of the same dithiocarbamate fungicide and the same amount of the same acid-based pesticide in the absence of the compatibility agent, over comparable periods of time, or (b) the sediment volume is equal or less than 2% of the volume of the combined dispersion when left to stand undisturbed for a period of 10, preferably 30 minutes. The liquid carrier is most typically aqueous and often water. In some embodiments, the weight ratio between the organic phosphoric acid ester-based compatibility agent and acid-based pesticide and/or derivative is from about 1:1 to about 1:4. In some embodiments, the weight ratio between the organic phosphoric acid ester-based compatibility agent and acid-based pesticide etc., is from about 1:1 to about 1:2.

In some glyphosate salt embodiments, the weight ratio between the organic phosphoric acid ester-based compatibility agent and the glyphosate salt is from about 1:1 to about 1:4. In some embodiments, the weight ratio between the organic phosphoric acid ester-based compatibility agent and the glyphosate salt is from about 1:1 to about 1:2.

In some embodiments, the weight ratio between the organic phosphoric acid ester-based compatibility agent and the dithiocarbamate fungicide is from about 1:1 to about 1:4. In some embodiments, the weight ratio between the organic phosphoric acid ester-based compatibility agent and the dithiocarbamate fungicide is from about 1:1 to about 1:2.

In some Mancozeb embodiments, the weight ratio between the organic phosphoric acid ester-based compatibility agent and the Mancozeb is from about 1:1 to about 1:4. In some Mancozeb embodiments, the weight ratio between the organic phosphoric acid ester-based compatibility agent and the mancozeb is from about 1:1 to about 1:2.

In some embodiments, the weight ratio between the organic phosphoric acid ester-based compatibility agent and the dithiocarbamate fungicide is about 1:1.6. In some embodiments, the weight ratio between the organic phosphoric acid ester-based compatibility agent and the dithiocarbamate fungicide is about 1:1.24.

In some Mancozeb embodiments, the weight ratio between organic phosphoric acid ester-based compatibility agent and Mancozeb is about 1:1.6. In some embodiments, the weight ratio between organic phosphoric acid ester-based compatibility agent and Mancozeb is about 1:1.24.

In some embodiments, the organic phosphoric acid ester-based compatibility agent is an alkyl polyethylene glycol ether phosphoric acid mono/diester (50/50), acid form. In some embodiments, the organic phosphoric acid ester-based compatibility agent is isotridecyl polyoxethyl (6 EO) phosphoric acid mono/diester, available as Hostaphat® 1306. In some Mancozeb embodiments, the weight ratio between the Hostaphat® 1306 and the Mancozeb is from about 1:1 to about 1:4. In some embodiments, the weight ratio between the Hostaphat® 1306 and the Mancozeb is from about 1:1 to about 1:2.

In some Mancozeb embodiments, the weight ratio between Hostaphat® 1306 and Mancozeb is about 1:1.6. In some embodiments, the weight ratio between Hostaphat® 1306 and Mancozeb is about 1:1.24.

In some Mancozeb embodiments, the weight ratio between organic phosphoric acid ester-based compatibility agent and Mancozeb is about 0.625:1. In some embodiments, the weight ratio between organic phosphoric acid ester-based compatibility agent and Mancozeb is about 0.8:1.

In some embodiments, the weight ratio between the dithiocarbamate fungicide and the acid-based pesticide is from about 10:1 to about 1:10, or from about 5:1 to about 1:5, or from about 2:1 to about 1:2. In some embodiments, the weight ratio between the dithiocarbamate fungicide and the acid-based pesticide is about 1:1.

The at least one organic phosphoric acid ester-based compatibility agent is selected from the group of, mono-esters of phosphoric acid; diesters of phosphoric acid; triesters of phosphoric acid; alkoxylated phosphoric acid mono-esters; alkoxylated phosphoric acid mono-esters; alkoxylated phosphoric acid di-esters; alkoxylated phosphoric acid tri-esters; alkoxylated polyarylphenol phosphate esters; alkyl alkoxylated phosphoric acid mono-esters; alkyl alkoxylated phosphoric acid di-esters; tristyrylphenol ethoxylate phosphate di-ester; tristyrylphenol ethoxylate phosphate tri-ester; styryl substituted ethoxylated and phosphorylated phenols; phosphoric acid decyl octyl ester; phosphate esters of alcohol ethoxylates; phosphorylated, ethoxylated fatty alcohols phosphorylated, propoxylated fatty alcohols; phosphorylated ethylene oxide/propylene oxide block polymers; alkyl polyalkylene glycol ether phosphoric acid ester acid form; and salts and/or mixtures thereof.

While the phosphoric acid ester-based compatibility agent definition encompasses a broad group of useful compatibility agents, alkyl polyalkylene glycol ether phosphoric acid ester acid form, alkane phosphate esters and diesters, and alcohol ethoxylate/propoxylate phosphate esters, provide useful exemplary models that can serve to demonstrate the broader range. In this respect it is worthwhile mentioning some usefully available products including, Phosphoric acid, decyl octyl ester; Heptyl nonyl hydrogen phosphate; alcohol ethoxylate/propoxylate phosphate esters; mixtures of esters of phosphoric acid and tridecyl ether; alcohol ethoxylate phosphate esters; phosphate esters of alcohol alkoxylates, including phosphate mono-, di- and tri-esters (and mixtures thereof), where the phosphate ester functionality is, an ethoxylated (and/or propoxylated) alcohol.

The alkoxylated alcohols mentioned above are exemplified (though not limited), by those model compatibility agents where the phosphate ester functionality is an alkoxylated C₁₀-C₁₄ alcohol and a chain length of approximately 30; an alkoxylated oleyl alcohol and a chain length of approximately 27; an alkoxylated C₈-C₁₀ alcohol and a chain length of about 14; an alkoxylated tridecyl alcohol and a chain length of approximately 27; mixed di- and tri-esters, where the phosphate ester functionality is an alkoxylated C₁₀-C₁₄ alcohol and a chain length of approximately 27.

In all the above non-limiting examples the alkoxylated alcohols are preferably ethoxylated, propoxylated or mixed ethoxylated/propoxylated alcohols.

It is worth mentioning the commercial products AGRILAN® 1028, SERVOXYL® VPDZ 3/100, HOSTAPHAT® 1306 and CRODAPHOS® 810A, simply because they were readily available and found to reinforce the convictions of the inventor that this defined group of compounds while being models to demonstrate the efficacy of the entire range of defined compatibility agents. In defining the boundaries of compounds usable in this invention it is also worth noting those compounds that while seemingly misleadingly similar to the claimed compatibility agents are found not to be within the scope of protection sought.

Using a very simply implemented protocol, inventors found that two commercial products were unsuitable, Soprophor® 3D 33 (2,4,6-Tris(1-phenylethyl) phenol polyoxyethylenated phosphates) and Soprophor® 4D384 (Tristyryphenol Ethoxylate Sulfate).

The inventors have not only provided a (non-exhaustive), list of usable compatibility agents that can overcome the on-going problem of the incompatibility of dithiocarbamate fungicides, exemplified by Mancozeb and acid-based pesticides exemplified by Glyphosate and Glufosinate salts in liquid, preferably aqueous, dispersions, but also provide a quick and simple protocol to screen potential compounds as compatibility agents for these heretofore dispersions.

A useful model AI combination for testing the utility of a potential compatibility agent is a combination of Mancozeb and Glyphosate potassium in water, wherein compatibility of the mancozeb compositions and the pesticide salt composition is measured as volume percentage of phase separation and/or sediment.

A simple protocol might be exemplified by the following. In a suitable container exemplified by a 100 mL measuring cylinder, the compatibility agent candidate, the model mancozeb composition and the glyphosate salt composition (e.g., Glyphosate K 540 SL) are added to water made up to 100 ml.

The cylinder is inverted 10 times between additions and inverted an additional 10 times after all components are incorporated and left to stand undisturbed for a period of time, and sedimentation volumes arc recorded after 10 minutes and 30 minutes. In general, when the sediment volume is equal or less than 2% after standing for 10 minutes undisturbed an acceptable compatibility agent is identified. Preferably the sediment volume is equal or less than 2% after standing for 30 minutes undisturbed.

While in principle, all three ingredients may be added to the suspending liquid in any order, for practical reasons it is easier to add the compatibility agent candidate to the water before adding the heretofore incompatible mancozeb and glyphosate salt compositions. However, when the candidate compatibility agent is added to the suspending medium, exemplified by water after the addition of the composition comprising the dithiocarbamate fungicide (mancozeb) and the composition comprising acid-based pesticide (Glyphosate salt), mixing is recommended prior to and/or during the addition of the candidate compatibility agent.

Another equally useful measure is to compare two separate dispersions prepared as above, when one dispersion contains the candidate compatibility agent and the other does not, and then comparing the rate and/or extent of phase separation and/or sedimentation of the suspensions.

When the rate and/or extent of phase separation and/or sedimentation in the dispersion containing the candidate is reduced by at least 30% as compared with the suspension (dispersion) of the same dithiocarbamate fungicide, and the same acid-based pesticide in the absence of the compound over a comparable period of time, the compound is identified as a useful compatibility agent within the scope of the invention.

The present invention provides a combination of (1) at least one dithiocarbamate fungicide, (2) at least one acid-based pesticide and (3) at least one alkyl polyalkylene glycol ether phosphoric acid ester acid form.

In some embodiments, the combination further comprises water.

The present invention provides a combination of (1) at least one dithiocarbamate fungicide, (2) at least one acid-based pesticide in salt form and (3) at least one alkyl polyalkylene glycol ether phosphoric acid ester acid form.

In some embodiments, the acid-based pesticide in salt form is in the form of alkali metal salts, alkaline earth metal salts and/or ammonium salts.

In some embodiments, the combination is an aqueous suspension.

In some embodiments, the water suspension is a tank mix.

The present invention provides a combination of (1) at least one dithiocarbamate fungicide, (2) at least one acid-based pesticide (3) at least one alkyl polyalkylene glycol ether phosphoric acid ester acid form and (4) water.

In some embodiments, the combination is a suspension composition comprising (1) at least one dithiocarbamate fungicide, (2) at least one acid-based pesticide 3) at least one alkyl polyalkylene glycol ether phosphoric acid ester acid form and (4) water.

The present invention also provides a suspension prepared using any one of the combinations or compositions disclosed herein.

The present invention also provides a process for preparing a suspension comprising mixing (1) at least one dithiocarbamate fungicide, (2) at least one acid-based pesticide. (3) at least one alkyl polyalkylene glycol ether phosphoric acid ester acid form and (4) water.

The present invention provides a combination which is a suspension comprising (1) 2% w/w of composition comprising about 400 g/l dithiocarbamate fungicide based on the total weight of the combination, (2) 2% w/w of composition comprising about 540 g/l of acid-based pesticide based on the total weight of the combination. (3) 0.5% w/w of alkyl polyalkylene glycol ether phosphoric acid ester acid form based on the total weight of the combination and (4) water.

The present invention provides a combination which is a suspension comprising. (1) 2% w/w of a composition comprising about 400 g/l of mancozeb based on the total weight of the combination, (2) 2% w/w of a composition comprising about 540 g/l of glyphosate potassium based on the total weight of the combination, (3) 0.5% w/w of Hostaphat® 1306 based on the total weight of the combination and (4) water.

The suspension compositions of the invention are typically aqueous suspensions.

The present invention also provides a package or kit comprising (1) at least one dithiocarbamate fungicide, (2) at least one acid-based pesticide, and (3) at least one alkyl polyalkylene glycol ether phosphoric acid ester acid form.

The present invention also provides a package or kit comprising (i) at least one alkyl polyalkylene glycol ether phosphoric acid ester acid form and (ii) (1) at least one composition comprising at least one dithiocarbamate fungicide and/or (2) at least one composition comprising at least one acid-based pesticide.

The present invention also provides the use of at least one alkyl polyalkylene glycol ether phosphoric acid ester acid form for dispersing (1) at least one dithiocarbamate fungicide and (2) at least one acid-based pesticide in water.

The present invention also provides the use of at least one alkyl polyalkylene glycol ether phosphoric acid ester acid form for reducing the phase separation and/or sedimentation of an aqueous suspension comprising (1) at least one dithiocarbamate fungicide and (2) at least one acid-based pesticide, wherein the rate and/or extent of phase separation and/or sedimentation of the suspension is lower than the rate and/or extent of phase separation and/or sedimentation of the suspension when (1) and (2) are mixed in the absence of alkyl polyalkylene glycol ether phosphoric acid ester acid form.

In some embodiments, acid-based pesticide refers to pesticide which has an acid group and/or derivative thereof such as salt and/or ester.

In some embodiments, acid-based pesticide is a carboxylic acid pesticide.

In some embodiments, acid-based pesticide is a sulphate pesticide.

In some embodiments, acid-based pesticide is a phosphate pesticide.

In some embodiments, acid-based pesticide is a phosphonate pesticide.

In some embodiments, the acid-based pesticide is a herbicide.

In some embodiments, the acid-based pesticide is the form of alkali metal salts, alkaline earth metal salts and/or ammonium salts.

In some embodiments, the alkyl polyalkylene glycol ether phosphoric acid ester acid form is in non-ionic form.

In some embodiments, alkyl polyalkylene glycol ether phosphoric acid ester acid form is anionic form.

In some embodiments, the alkyl polyalkylene glycol ether phosphoric acid ester acid form is mono ester.

In some embodiment the alkyl polyalkylene glycol ether phosphoric acid ester acid form is diester.

In some embodiments the alkyl polyalkylene glycol ether phosphoric acid ester acid form is mixture of mono and diester.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter belongs.

As used herein, the term “adjuvant” is defined as any substance that is not an active ingredient, but which enhances or is intended to enhance the effectiveness of the active ingredient, for example pesticide, with which it is used Adjuvants may include, but are not limited to, spreading agents, penetrants, compatibility agents, and drift retardants.

As used herein, the term “tank mix” means at least two of the components of the combination, mixture or composition of the present invention mixed in a tank.

As used herein, the term “plant” includes reference to the whole plant, plant organ (e.g., leaves, stems, twigs, roots, trunks, limbs, shoots, fruits etc.), or plant cells.

As used herein, the term “plant” includes reference to agricultural crops including field crops (soybean, maize, wheat, rice, etc.), vegetable crops (potatoes, cabbages, etc.) and perennial crops including fruits (peach, etc.).

As used herein, the term “propagation material” is to be understood to denote all the generative parts of the plant such as seeds and spores, vegetative structures such as bulbs, corms, tubers, rhizomes, roots stems, basal shoots, stolons and buds.
As used herein, the term “locus” includes not only areas where pests including weeds, insects, fungus, etc. may already exist, but also areas where a pest has yet to emerge, and also to areas under cultivation.

As used herein, the term “ha” refers to hectare.

The term “a” or “an” as used herein includes the singular and the plural, unless specifically stated otherwise. Therefore, the terms “a,” “an” or “at least one” can be used interchangeably in this application.

Throughout the application, descriptions of various embodiments use the term “comprising”; however, it will be understood by one of skill in the art, that in some specific instances, an embodiment can alternatively be described using the language “consisting essentially of” or “consisting of.”

The term “about” as used herein specifically includes ±10% from the indicated values in the range. In addition, the endpoints of all ranges directed to the same component or property herein are inclusive of the endpoints, are independently combinable, and include all intermediate points and ranges. It is understood that where a parameter range is provided, all integers within that range, and tenths thereof, are also provided by the invention. For example, “10-50%” includes 10%, 10.1%, 10.2%, etc. up to 50%.

Combining dithiocarbamate fungicide and acid-based pesticide and/or derivative thereof, especially salts such as potassium or sodium glyphosate and glufosinate in water is challenging due to incompatibility between the salt pesticide and the dithiocarbamate fungicide. It was surprisingly found that using an amount of alkyl polyalkylene glycol ether phosphoric acid ester acid form, increases the compatibility of the two active Ingredients (AIs) and results in improvement in the stability and suspensibility of the water suspension.

The combination with alkyl polyalkylene glycol ether phosphoric acid ester acid form, improves the physical properties of water suspensions comprising mancozeb and acid-based pesticide and/or derivative thereof.

### Combinations

The present invention provides a combination of (1) at least one dithiocarbamate fungicide, (2) at least one acid-based pesticide and (3) at least one alkyl polyalkylene glycol ether phosphoric acid ester acid form.

In some embodiments, the combination further comprises water.

The present invention provides a combination of (1) at least one dithiocarbamate fungicide, (2) at least one acid-based pesticide and/or derivative thereof, (3) at least one alkyl polyalkylene glycol ether phosphoric acid ester acid form, and (4) water.

The present invention provides a combination of (1) at least one dithiocarbamate fungicide, (2) at least one acid-based pesticide in salt form and (3) at least one alkyl polyalkylene glycol ether phosphoric acid ester acid form.

In some embodiments, alkyl polyalkylene glycol ether phosphoric acid ester acid form is a mixture of mono ester and diester.

In some embodiments, the mixture of mono ester and diester is in the acid form and/or the salt form thereof.

In some embodiments, the mixture of mono ester and diester is in the acid form.

In some embodiments, the mixture of mono ester and diester is in the salt form.

In some embodiments, the acid-based pesticide in salt form is in the form of alkali metal salts, alkaline earth metal salts and/or ammonium salts.

In some embodiments, the acid-based pesticide is a herbicide.

In some embodiments, the combination is a water suspension.

The present invention provides a combination of (1) at least one dithiocarbamate fungicide, (2) at least one acid-based pesticide (3) at least one alkyl polyalkylene glycol ether phosphoric acid ester acid form and (4) water.

In some embodiments, the combination is a suspension composition comprising (1) at least one dithiocarbamate fungicide, (2) at least one acid-based pesticide 3) at least one alkyl polyalkylene glycol ether phosphoric acid ester acid form and (4) water.

In some embodiments, acid-based pesticide refers to pesticide which has an acid group and/or derivative thereof such as salt and/or ester.

In some embodiments, acid-based pesticide is carboxylic acid pesticide.

In some embodiments, the acid-based pesticide is in the form of alkali metal salts, alkaline earth metal salts and/or ammonium salts.

In some embodiments, alkyl polyalkylene glycol ether phosphoric acid ester acid form refers to the acid form and/or the salt form thereof.

In some embodiments, the acid-based pesticide is in the acid form.

In some embodiments, the acid-based pesticide is in the salt form.

In some embodiments, the acid-based pesticide is in the ester form.

In some embodiments, the derivative is the acid in salt form.

In some embodiments, the derivative is the ester form.

In some embodiments, the combination further comprises at least one additional pesticide which is different from acid-based pesticide (2).

The present invention provides a combination of (1) at least one dithiocarbamate fungicide, (2) at least one acid-based pesticide, (3) at least one alkyl polyalkylene glycol ether phosphoric acid ester acid form and (4) water.

In some embodiments, the combination is a suspension composition comprising (1) at least one dithiocarbamate fungicide, (2) at least one acid-based pesticide, (3) at least one alkyl polyalkylene glycol ether phosphoric acid ester acid form and (4) water.

The present invention also provides a suspension prepared using any one of the combination or compositions disclosed herein.

The present invention provides a combination comprising (1) at least one dithiocarbamate fungicide (2) at least one acid-based pesticide in salt form (3) at least one alkyl polyalkylene glycol ether phosphoric acid ester acid form and (4) optionally at least one additional pesticide.

The present invention also provides a combination comprising (1) an amount of at least one dithiocarbamate fungicide, (2) an amount of at least one acid-based pesticide in salt form. (3) an amount of at least one alkyl polyalkylene glycol ether phosphoric acid ester acid form, (4) water, and (5) optionally one or more additional pesticides.

The present invention provides a combination comprising (1) composition comprising an amount of at least one dithiocarbamate fungicide, (2) composition comprising an amount of at least one acid-based pesticide. (3) an amount of at least one alkyl polyalkylene glycol ether phosphoric acid ester acid form. (4) water, and (5) optionally one or more additional pesticides.

The present invention provides a combination comprising (1) composition comprising an amount of at least one dithiocarbamate fungicide, (2) composition comprising an amount of at least one acid-based pesticide in salt form. (3) an amount of at least one alkyl polyalkylene glycol ether phosphoric acid ester acid form. (4) water, and (5) optionally one or more additional pesticides.

The present invention provides a combination comprising (1) composition comprising an amount of at least one dithiocarbamate fungicide, (2) composition comprising an amount of at least one acid-based pesticide, (3) an amount of at least one alkyl polyalkylene glycol ether phosphoric acid ester acid form and (4) optionally one or more additional pesticides.

The present invention provides a combination comprising (1) composition comprising an amount of at least one dithiocarbamate fungicide and one or more additional fungicide, (2) composition comprising an amount of at least one acid-based pesticide, (3) an amount of at least one alkyl polyalkylene glycol ether phosphoric acid ester acid form and (4) optionally one or more additional pesticides.

In some embodiments, the combination further comprises water.

In some embodiments, the fungicide is azole fungicide.

In some embodiments, the azole fungicide is prothioconazole.

In some embodiments, the fungicide is strobilurin fungicide.

In some embodiments, the strobilurin fungicide is picoxystrobin In some embodiments, the fungicide is SDHI fungicide.

In some embodiments, the SDHI fungicide is fluxapyroxad.

In some embodiments, the combination is a water suspension.

In some embodiments, the at least one dithiocarbamate fungicide is a composition which comprises dithiocarbamate fungicide active ingredient.

In some embodiments, dithiocarbamate fungicide is a composition comprising (1) a polyelectrolyte, (2) a dithiocarbamate fungicide, and (3) at least one agriculturally acceptable carrier.

In some embodiments, composition comprising an amount of at least one dithiocarbamate fungicide and one or more additional fungicide is a composition which comprises (1) a polyelectrolyte, (2) a dithiocarbamate fungicide, and (3) at least one agriculturally acceptable carrier.

In some embodiments, dithiocarbamate fungicide is a composition comprising (1) a macromolecular complex comprising a dithiocarbamate fungicide and a polyelectrolyte, and (2) optionally an azole fungicide.

In some embodiments, dithiocarbamate fungicide is a composition comprising (1) a macromolecular complex comprising a dithiocarbamate fungicide and a polyelectrolyte and (2) an azole fungicide.

In some embodiments, dithiocarbamate fungicide is a composition comprising (1) a macromolecular complex comprising a dithiocarbamate fungicide and a polyelectrolyte, (2) an azole fungicide and (3) a strobilurin fungicide.

In some embodiments, the polyelectrolyte is a polycation.

In some embodiments, the at least one acid-based pesticide is a composition which comprises acid-based pesticide.

In some embodiments, the alkyl polyalkylene glycol ether phosphoric acid ester acid form is a composition with active ingredient.

In some embodiments, where the at least one dithiocarbamate fungicide is a composition which comprises a dithiocarbamate fungicide active ingredient, the weight or ratios refers to the weight of the dithiocarbamate fungicide active ingredient in the combination.

In some embodiments, when the dithiocarbamate fungicide is a composition comprising the dithiocarbamate fungicide active ingredient, the content is 2% by weight based on the total combination refers to the weight of the composition comprising dithiocarbamate fungicide active ingredient.

In some embodiments, where the at least one acid-based pesticide is a composition which comprises an acid-based pesticide active ingredient, the weight, or ratios refers to the weight of the acid-based pesticide active ingredient in the combination.

In some embodiments, when the acid-based pesticide is a composition comprising the acid-based pesticide active ingredient, the content is 2% by weight based the total combination refers to the weight of the composition comprising acid-based pesticide.

In some embodiments, the alkyl polyalkylene glycol ether phosphoric acid ester acid form and the at least one dithiocarbamate fungicide are formulated together in a composition.

In some embodiments, the alkyl polyalkylene glycol ether phosphoric acid ester acid form and the at least one acid-based pesticide are formulated together in a composition.

The present invention relates to a combination comprising (1) at least one dithiocarbamate fungicide, (2) at least one acid-based pesticide, (3) at least one alkyl polyalkylene glycol ether phosphoric acid ester acid form. (4) water and (5) optionally one or more additional pesticides.

The present invention relates to a suspension comprising (1) at least one dithiocarbamate fungicide, (2) at least one acid-based pesticide. (3) at least one alkyl polyalkylene glycol ether phosphoric acid ester acid form. (4) water, and (5) optionally one or more additional pesticides.

In some embodiments, the suspension is prepared by mixing (1) a composition comprising at least one dithiocarbamate fungicide (2) a composition comprising at least one acid-based pesticide and (3) at least one alkyl polyalkylene glycol ether phosphoric acid ester acid form, optionally in a suspending medium.

In some embodiments, the suspension is prepared by mixing (1) a composition comprising the at least one dithiocarbamate fungicide and the at least one alkyl polyalkylene glycol ether phosphoric acid ester acid form and (2) a composition comprising at least one acid-based pesticide, optionally in a suspending medium.

In some embodiments, the suspension is prepared by mixing (1) a composition comprising at least one dithiocarbamate fungicide and (2) a composition comprising at least one acid-based pesticide and/or derivative thereof and the at least one alkyl polyalkylene glycol ether phosphoric acid ester acid form, optionally in a suspending medium.

In some embodiments, the suspension is prepared by mixing a composition comprising the at least one dithiocarbamate fungicide and the at least one alkyl polyalkylene glycol ether phosphoric acid ester acid form and (2) a composition comprising the at least one acid-based pesticide and/or derivative thereof and the at least one alkyl polyalkylene glycol ether phosphoric acid ester acid form, optionally in a suspending medium.

In some embodiments a suspending medium is exemplified by water.

In some embodiments, the dithiocarbamate fungicide is a composition which comprises dithiocarbamate fungicide.

In some embodiments, the acid-based pesticide is a composition which comprises acid-based pesticide.

In some embodiments, the combination is water-based composition.

The present invention provides a water-based composition comprising (1) at least one dithiocarbamate fungicide (2) at least one acid-based pesticide in salt form (3) at least one alkyl polyalkylene glycol ether phosphoric acid ester acid form and (4) optionally at least one additional pesticide.

The present invention also provides a water-based composition comprising (1) an amount of at least one dithiocarbamate fungicide, (2) an amount of at least one acid-based pesticide in salt form, (3) an amount of at least one alkyl polyalkylene glycol ether phosphoric acid ester acid form, (4) water, and (5) optionally one or more additional pesticides.

In some embodiments, the additional pesticide is fungicide.

In some embodiments, acid-based herbicide includes but is not limited to glyphosate salt, glufosinate salt, bispyribac salt and 2,4 D salt.

In some embodiments, the at least one acid-based pesticide is in the form of an agriculturally acceptable salt.

In some embodiments, the agriculturally acceptable salt is an alkali or alkaline earth metal salts such as sodium, potassium, lithium, magnesium, calcium, salts of other metals as copper, iron, zinc, cobalt, or nickel. In some embodiments, the salt contains ammonium group. In some embodiments the salt comprises substituted ammonium salts of any kind.

In some embodiments, the acid-based pesticide is an acid-based herbicide which is a glyphosate salt.

In some embodiments, the acid-based herbicide is glyphosate sodium.

In some embodiments, the acid-based herbicide is glyphosate potassium.

In some embodiments, the acid-based herbicide is glyphosate ammonium.

In some embodiments, the alkyl polyalkylene glycol ether phosphoric acid ester acid form is in the salt form.

In some embodiments, the alkyl polyethylene glycol ether phosphoric acid ester acid form is in the acid form.

In some embodiments, the alkyl polyalkylene glycol ether phosphoric acid ester acid form is in non-ionic form.

In some embodiments, alkyl polyalkylene glycol ether phosphoric acid ester acid form is anionic form.

In some embodiments, the alkyl polyalkylene glycol ether phosphoric acid ester acid form is mono ester.

In some embodiment the alkyl polyalkylene glycol ether phosphoric acid ester acid form is diester.

In some embodiments the alkyl polyalkylene glycol ether phosphoric acid ester acid form is mixture of mono and diester.

In some embodiments, the weight ratio between the alkyl polyalkylene glycol ether phosphoric acid ester acid form and acid-based pesticide is from about 1:1 to about 1:4. In some embodiments, the weight ratio between the alkyl polyalkylene glycol ether phosphoric acid ester acid form and acid-based pesticide is from about 1:1 to about 1:2.

In some embodiments, the weight ratio between the alkyl polyalkylene glycol ether phosphoric acid ester acid form and the glyphosate salt is from about 1:1 to about 1:4. In some embodiments, the weight ratio between the alkyl polyalkylene glycol ether phosphoric acid ester acid form and the glyphosate salt is from about 1:1 to about 1:2.

In some embodiments, the weight ratio between the alkyl polyalkylene glycol ether phosphoric acid ester acid form and the dithiocarbamate fungicide is from about 1:1 to about 1:4. In some embodiments, the weight ratio between the alkyl polyalkylene glycol ether phosphoric acid ester acid form and the dithiocarbamate fungicide is from about 1:1 to about 1:2.

In some embodiments, the weight ratio between the alkyl polyalkylene glycol ether phosphoric acid ester acid form and the mancozeb is from about 1:1 to about 1:4. In some embodiments, the weight ratio between the alkyl polyalkylene glycol ether phosphoric acid ester acid form and the mancozeb is from about 1:1 to about 1:2.

In some embodiments, the weight ratio between the alkyl polyalkylene glycol ether phosphoric acid ester acid form and the dithiocarbamate fungicide is about 1:1.6. In some embodiments, the weight ratio between the alkyl polyalkylene glycol ether phosphoric acid ester acid form and the dithiocarbamate fungicide is about 1:1.24.

In some embodiments, the weight ratio between alkyl polyalkylene glycol ether phosphoric acid ester acid form and mancozeb is about 1:1.6. In some embodiments, the weight ratio between alkyl polyalkylene glycol ether phosphoric acid ester acid form and mancozeb is about 1:1.24.

In some embodiments, the alkyl polyalkylene glycol ether phosphoric acid ester acid form is Hostaphat® 1306.

In some embodiments, the weight ratio between the Hostaphat® 1306 and the mancozeb is from about 1:1 to about 1:4. In some embodiments, the weight ratio between the Hostaphat® 1306 and the mancozeb is from about 1:1 to about 1:2.

In some embodiments, the weight ratio between Hostaphat® 1306 and mancozeb is about 1:1.6. In some embodiments, the weight ratio between Hostaphat® 1306 and mancozeb is about 1:1.24.

In some embodiments, the weight ratio between alkyl polyalkylene glycol ether phosphoric acid ester acid form and mancozeb is about 0.625:1. In some embodiments, the weight ratio between alkyl polyalkylene glycol ether phosphoric acid ester acid form and mancozeb is about 0.8:1.

In some embodiments, the weight ratio between the dithiocarbamate fungicide and the acid-based pesticide is from about 10:1 to about 1:10, or from about 5:1 to about 1:5, or from about 2:1 to about 1:2. In some embodiments, the weight ratio between the dithiocarbamate fungicide and the acid-based pesticide is about 1:1.

In some embodiments, dithiocarbamate fungicide is mancozeb.

In some embodiments, acid-based pesticide is potassium glyphosate.

In some embodiments, the dithiocarbamate fungicide in the composition is formulated in the presence of at least one polyelectrolyte.

In some embodiments, the mancozeb in the composition is formulated in the presence of at least one polyelectrolyte. (as described in Indian Provisional Application No. 202011052575; U.S. provisional No. 63/194,343)

The present invention provides a combination which is a suspension comprising (1) 2% w/w of composition comprising about 400 g/l dithiocarbamate fungicide based on the total weight of the combination, (2) 2% w/w of composition comprising about 540 g/l of acid-based pesticide based on the total weight of the combination, (3) 0.5% w/w of alkyl polyalkylene glycol ether phosphoric acid ester acid form based on the total weight of the combination and (4) water.

The present invention provides a combination which is a suspension comprising. (1) 2% w/w of a composition comprising about 400 g/l of mancozeb based on the total weight of the combination, (2) 2% w/w of a composition comprising about 540 g/l of glyphosate potassium based on the total weight of the combination, (3) 0.5% w/w of Hostaphat® 1306 based on the total weight of the combination and (4) water.

The suspension combination compositions of the invention are typically aqueous suspensions.

In some embodiments, the composition comprising mancozeb is as described in as described in Indian Provisional Application No. 202011052575; U.S. provisional No. 63/194,343.

In some embodiments, the amount of the mancozeb in the composition comprising mancozeb is 400 g/l.

In some embodiments, the amount of the mancozeb in the combination is about 0.62 g/l.

The present invention provides a combination of (1) mancozeb fungicide, (2) glyphosate K and (3) Hostaphat® 1306.

The present invention provides a combination of (1) composition comprising mancozeb fungicide, (2) composition comprising glyphosate K and (3) Hostaphat® 1306.

The present invention provides a combination of (1) a composition comprising (i) a polyelectrolyte, (ii) a dithiocarbamate fungicide, and (iii) at least one agriculturally acceptable carrier. (2) composition comprising glyphosate K and (3) Hostaphat® 1306.

The present invention provides a combination of (1) a composition comprising (i) a polyelectrolyte, (ii) a mancozeb, and (iii) at least one agriculturally acceptable carrier. (2) composition comprising glyphosate K and (3) Hostaphat® 1306.

The present invention provides the mixture of mancozeb, prothioconazole and glyphosate.

The present invention provides the mixture of mancozeb, prothioconazole, picoxystrobin and glyphosate.

The present invention provides the mixture of mancozeb and glyphosate.

### Alkyl Polyalkylene Glycol Ether Phosphoric Acid Ester Acid Form

Surprisingly, it was found that alkyl polyalkylene glycol ether phosphoric acid ester acid form significantly improves the compatibility between compositions comprising mancozeb and compositions comprising acid-based pesticide and/or derivatives thereof.

In some embodiments, the alkyl polyalkylene glycol ether phosphoric acid ester acid form is a mixture comprising mono ester and/or diester in the acid form.

In some embodiments, alkyl polyalkylene glycol ether phosphoric acid ester acid form is a mixture comprising mono ester and/or diester in its salt form.

In some embodiments, the alkyl polyalkylene glycol ether phosphoric acid ester acid form is an alkyl alkoxylated phosphate ester.

In some embodiments, the structure of the alkyl polyalkylene glycol ether phosphoric acid ester acid form is (R(OA)ₙO)_{y}—PO(OH)ₘ and salts thereof.

In some embodiments, the structure of the alkyl polyalkylene glycol ether phosphoric acid ester acid form is anionic form of (R(OA)ₙO)_{y}—PO(OH)ₘ.

Wherein R is a saturated or unsaturated optionally branched alkyl, carbon chain; A is C₂-C₃; n is more than 2; y is 1 or 2; mi s 1 or 2.

In some embodiments, R is a saturated or unsaturated, optionally branched, alkyl carbon chain; A is C₂; n is 3-20; y is 1 or 2; m is 1 or 2.

In some embodiments, the alkyl polyethylene glycol ether phosphoric acid mono/diester comprises a polyethoxylate of 3-12 ethylene oxide (EO) groups.

In some embodiments, the alkyl polyethylene glycol ether phosphoric acid mono/diester comprises a polyethoxylate of 6 ethylene oxide (EO) groups.

In some embodiments, the alkyl (R) is linear.

In some embodiments, the alkyl (R) is a fatty chain.

In some embodiments, R is C₆ alkyl.

In some embodiments, the R is C₁₈ alkyl.

In some embodiments, the R is C₁₃ alkyl.

In some embodiments, alkyl is branched and/or straight-chain saturated and/or unsaturated aliphatic carbon chain having the specified number of carbon atoms. Thus, Cn as in “Cn alkyl” includes n carbons in a linear or branched arrangement.

In some embodiments, the alkyl polyethylene glycol ether phosphoric acid mono or diester acid form has the structure of

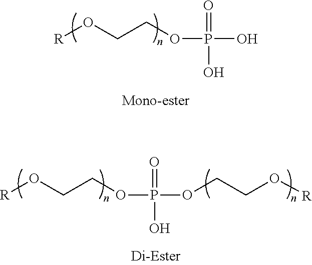

In some embodiments, the alkyl (R) is linear.

In some embodiments, the alkyl (R) is a fatty chain.

In some embodiments, R is C₆ alkyl.

In some embodiments, the R is Cis alkyl.

In some embodiments, the R is C₁₃ alkyl.

In some embodiments, the alkyl polyalkylene glycol ether phosphoric acid ester acid form is the alkyl polyethylene glycol ether phosphoric acid mono/diester.

In some embodiments, the about 50% of the alkyl polyethylene glycol ether phosphoric acid is mono ester and about 50% is diester.

In some embodiments, the alkyl polyalkylene glycol ether phosphoric acid ester acid form of the invention is Hostaphat® 1306, an alkyl polyethylene glycol ether phosphoric acid mono/diester (50/50), acid form.

In some embodiments, the alkyl polyalkylene glycol ether phosphoric acid ester acid form is Isotridecyl polyoxethyl (6 EO) phosphoric acid mono/diester, ca. 96% liquid acid form.

In some embodiments, Hostaphat® 1306 by Clariant is Isotridecyl polyoxethyl (6 EO) phosphoric acid mono/diester, ca. 96% liquid acid form.

In some embodiments, the alkyl polyethylene glycol ether phosphoric acid mono/diester comprises a polyethoxylate of 3-12 ethylene oxide (EO) groups.

In some embodiments, the alkyl polyethylene glycol ether phosphoric acid ester acid form comprises a polyethoxylate of 6 ethylene oxide (EO) groups.

In some embodiments, alkyl polyethylene glycol ether phosphoric acid ester acid form is Hostaphat®1306.

In some embodiments, alkyl polyethylene glycol ether phosphoric acid mono/diester is Agrilan® 1028.

In some embodiments, alkyl polyethylene glycol ether phosphoric acid mono/diester is SERVOXYL® VPDZ 3/100.

### Use and Method

The present invention also provides the use of at least one alkyl polyalkylene glycol ether phosphoric acid ester acid form for dispersing (1) at least one dithiocarbamate fungicide, and (2) at least one acid-based pesticide and/or derivative thereof in a suspension combination.

The present invention also provides the use of at least one alkyl polyalkylene glycol ether phosphoric acid ester acid form for reducing the rate and/or extent of phase separation and/or sedimentation of an aqueous suspension comprising (1) at least one dithiocarbamate fungicide, and (2) at least one acid-based pesticide wherein, the rate and/or extent of phase separation and/or sedimentation of the suspension is lower than the rate and/or extent of phase separation and/or sedimentation of a suspension when (1) and (2) are combined in a suspension in the absence of alkyl polyalkylene glycol ether phosphoric acid ester acid form.

In some embodiments, the extent of sedimentation is reduced by at least 30%, at least 40%, at least 50% as compared with a suspension of the dithiocarbamate fungicide, and the acid-based pesticide in the absence of alkyl polyalkylene glycol ether phosphoric acid ester acid form over a comparable period of time.

The present invention provides the use of alkyl polyalkylene glycol ether phosphoric acid ester acid form for preparing a suspension composition comprising. (1) a composition comprising at least one dithiocarbamate fungicide and (2) a composition comprising at least one acid-based pesticide and/or derivative thereof.

The present invention also relates to use of alkyl polyalkylene glycol ether phosphoric acid ester acid form for stabilizing aqueous suspensions comprising dithiocarbamate fungicide, and (2) acid-based pesticide in salt form.

In some embodiments, the suspension comprises additional pesticide.

In some embodiments, dithiocarbamate fungicide is a composition which comprises a dithiocarbamate fungicide active ingredient and optionally additional fungicide.

In some embodiments, the acid-based pesticide is a composition which comprises acid-based pesticide active ingredient.

In some embodiments, the acid-based pesticide is in salt form, particularly agriculturally acceptable salt form.

In some embodiments, additional pesticide is a fungicide.

In some embodiments, herbicides include but are not limited to glyphosate salt, glufosinate salt, bispiribac salt and 2,4 D salt.

In some embodiments, the herbicide is glyphosate sodium.

In some embodiments, the herbicide is glyphosate potassium.

In some embodiments, the herbicide is glyphosate ammonium.

In some embodiments, the method of use of alkyl polyalkyleneglycol ether phosphoric acid ester acid form is achieved by adding the alkyl polyalkylene glycol ether phosphoric acid ester acid form to a suspending medium, exemplified by water prior to the addition of the composition comprising dithiocarbamate fungicide and/or the composition comprising acid-based pesticide and/or derivative thereof.

In some embodiments, when the alkyl polyalkylene glycol ether phosphoric acid ester acid form is added to the suspending medium, exemplified by water after the addition of the composition comprising dithiocarbamate fungicide and the composition comprising acid-based pesticide and/or derivative thereof, mixing is required prior to and/or during the addition of the alkyl polyalkylene glycol ether phosphoric acid ester acid form.

In some embodiments, dithiocarbamate fungicide is mancozeb.

In some embodiments, acid-based pesticide and/or derivative thereof is glyphosate Potassium.

### Dithiocarbamate Fungicide

In some embodiments, the dithiocarbamate fungicide is a composition which comprises dithiocarbamate fungicide active ingredient.

In some embodiments, the composition which comprises dithiocarbamate fungicide active ingredient is solid.

In some embodiments, the composition which comprises dithiocarbamate fungicide active ingredient is granule.

In some embodiments, the composition which comprises dithiocarbamate fungicide active ingredient is wettable dispersible granules (WDG).

In some embodiments, the composition which comprises dithiocarbamate fungicide active ingredient is an oil dispersion (OD).

In some embodiments, a composition which comprises dithiocarbamate fungicide active ingredient is a suspension concentrate (SC).

In some embodiments, the composition which comprises dithiocarbamate fungicide active ingredient is a suspoemulsion (SE).

In some embodiments, the composition which comprises dithiocarbamate fungicide active ingredient additionally comprises at least one polyelectrolyte.

In some embodiments, dithiocarbamate fungicide is formulated in the presence of polyelectrolyte complex as described in PCT/IB2021/054696.

In some embodiments, the dithiocarbamate fungicide refers to composition where the dithiocarbamate fungicide active ingredient is formulated in the presence of polyelectrolyte as described in Indian Provisional Application No. 202011052575; U.S. provisional application No. 63/194,343.

In some embodiments, dithiocarbamate fungicide active ingredient is in a macromolecular complex form with a polyelectrolyte, as described in WO2020/240478.

In some embodiments, the dithiocarbamate fungicide is formulated in presence of additional fungicide.

In some embodiments, the dithiocarbamate fungicide is a dimethyldithiocarbamate. In some embodiments, the dimethyldithiocarbamate is ferbam (iron (III) dimethyldithiocarbamate), ziram (zinc dimethyldithiocarbamate), thiram (dimethylcarbamothioylsul fanyl-N,N-dimethyldithiocarbamate), propineb (zinc propylenebis (dithiocarbamate), or an ethylenebisdithiocarbamate.

A preferred dithiocarbamate is or comprises an ethylene bisdithiocarbamate (EBDC) such as sodium ethylenebisdithiocarbamate (nabam), zinc ammoniate ethylenebis (dithiocarbamate)-poly (ethylenethiuram disulfide) (metiram). A more preferred EBDC is in the form of a complex with manganese (maneb), zinc (zineb) or, most preferably, a combination of manganese and zinc (mancozeb; zinc;manganese (2+);N-[2-(sulfidocarbothioylamino)ethyl]carbamodithioate or [[2-[(dithiocarboxy)amino]ethyl] carbamodithioato (2-)-κS,κS′] manganese mixture with [2-[(dithiocarboxy) amino]ethyl] carbamodithioato (2-)-κS,κS′]zinc). A preferred dithiocarbamate in a macromolecular complex of the invention is mancozeb.

In some embodiments, the dithiocarbamate fungicide is mancozeb. Mancozeb tech. (Mancozeb bulk raw active material), that is available commercially contains mancozeb and inert additives. In some embodiments, the mancozeb tech. contains 86.7% w/w of mancozeb.

The present invention relates to combinations comprising (1) a composition comprising a macromolecular complex comprising a dithiocarbamate fungicide and a polyelectrolyte (2) a composition comprising acid-based pesticide, (3) an alkyl polyalkylene glycol ether phosphoric acid ester acid form, (4) water and (5) optionally at least one additional pesticide.

In some embodiments, the polyelectrolyte is a polycation.

In some embodiments, polycation is chitosan.

In some embodiments, the polycation is chitosan (CTS), epsilon-poly-L-lysine (∈-PLL), poly allyl amine (PAA), or any combination thereof.

In some embodiments, polycation is chitosan.
In some embodiments, the polyelectrolyte is a polycation.

In some embodiments, the composition comprises a macromolecular complex comprising the polycation and the dithiocarbamate fungicide, wherein the macromolecular complex is characterized by intermolecular, non-covalent interactions, preferably electrostatic interactions such as ionic interactions, hydrogen bonds and van der Waals forces, such as dipole-dipole interactions, between the polycation and the dithiocarbamate fungicide.

In some embodiments, the macromolecular matrix is substantially free or free of polyanion. In some embodiments, the dithiocarbamate fungicide is in a macromolecular complex with a polycation.

In some embodiments, the macromolecular complex is characterized by intermolecular, non-covalent interactions between the polycation and the dithiocarbamate fungicide. In some embodiments, the macromolecular complex is characterized by intermolecular, non-covalent interactions between donor and acceptor groups of the polycation and the dithiocarbamate fungicide.

In some embodiments, the intermolecular, non-covalent interactions are electrostatic interactions.

In some embodiments, the electrostatic interactions are ionic interactions, hydrogen bonds and van der Waals forces.

In some embodiments, the macromolecular complex is characterized by ionic interactions between donor and acceptor groups of the polycation and the dithiocarbamate fungicide. In some embodiments, the intermolecular, non-covalent interactions between the polycation and the dithiocarbamate fungicide are ionic interactions.

In some embodiments, the van der Waals forces are dipole-dipole interactions between the polycation and the dithiocarbamate fungicide.

In some embodiments, the mancozeb is formulated in an aqueous composition.

In some embodiments, the aqueous composition is a suspension concentrate.

In some embodiments, aqueous composition is a suspoemulsion.

In some embodiments, the dithiocarbamate fungicide is a mixture of two dithiocarbamate fungicidal active ingredients.

In some embodiments, a batch of dithiocarbamate fungicide is a mixture of dithiocarbamate fungicide active ingredient(s) and at least one additive. In some embodiments, the batch of dithiocarbamate fungicide is a mixture of the dithiocarbamate fungicide active ingredient(s) and a stabilizer. In some embodiments, the stabilizer is an anionic surfactant. In some embodiments, the stabilizer is a salt of lignosulfonic acid such as lignosulfonate calcium.

Composition Comprising Acid-Based Pesticide and/or Derivative Thereof

In some embodiments, acid-based pesticide is in acid form.

In some embodiments, acid-based pesticide is in salt form.

In some embodiments, acid-based pesticide is an ester derivative.

In some embodiments, the composition comprising acid-based pesticide is a liquid composition.

In some embodiments, the composition comprising acid-based pesticide is a solid composition.

In some embodiments, the acid-based pesticide is in salt form.

In some embodiments, the salt is metal salt exemplified by sodium, potassium.

In some embodiments, the salt of the pesticide is an alkaline salt.

In some embodiments, the salt is an ammonium salt.

In some embodiments, the salt is an amine salt.

### Additional Pesticide

With reference to the inventive combination, the term, additional pesticide, refers to any or all of fungicide, herbicide, insecticide, nematocide, biocide, and the like.

In some embodiments, additional fungicide is an azole fungicide, strobilurin fungicide, carboxamides/SDHI (e.g. fluxapyroxad), a morpholine (e.g. fenpropidin) and any combination thereof.

Dithiocarbamate fungicides, azole fungicides and strobilurin fungicides that may be used in connection with the present invention are described herein below.

In some embodiments, the azole fungicide is selected from the group consisting of difenoconazole; metconazole; myclobutanil; propiconazole; triadimefon; cyproconazole; fenbuconazole; flusilazole; flutriafol; ipconazole; tetraconazole; triadimenol; triticonazole; tebuconazole; prothioconazole; and combinations thereof. In some embodiments, the azole fungicide is selected from the group consisting of tebuconazole; prothioconazole; and a combination thereof.

In some embodiments, the combination further comprises a strobilurin fungicide. In some embodiments, the strobilurin fungicide is selected from the group consisting of, mandestrobin; pyrametostrobin; enestroburin; bifujunzhi; metominostrobin; coumethoxystrobin; coumoxystrobin; pyraclostrobin; trifloxystrobin; picoxystrobin; orysastrobin; kresoxim-methyl; fluoxastrobin; dimoxystrobin; azoxystrobin; picoxystrobin; and any and all combinations thereof. In some embodiments, the strobilurin fungicide is selected from the group consisting of picoxystrobin; azoxystrobin; and any combinations thereof.

### Process for Preparing the Combination

The present invention provides a process for preparing the inventive combination, the process comprising mixing (1) composition comprising at least one dithiocarbamate fungicide and optionally additional fungicide(s), (2) composition comprising at least one acid-based pesticide and/or derivative thereof, (3) at least one alkyl polyalkylene glycol ether phosphoric acid ester acid form, and (4) water.

In some embodiments the alkyl polyalkylene glycol ether phosphoric acid ester acid form is added to water prior to adding either or both of, the composition comprising dithiocarbamate fungicide and the composition comprising acid-based pesticide and/or derivative thereof.

The present invention provides a process for preparing a combination of the invention, the process comprising mixing (1) composition comprising dithiocarbamate fungicide and optionally additional fungicide(s), (2) composition comprising acid-based pesticide and/or derivative thereof, (3) an alkyl polyalkylene glycol ether phosphoric acid ester acid form, and (4) water.

In some embodiments the alkyl polyalkylene glycol ether phosphoric acid ester acid form is added to water prior to adding either or both of the composition comprising dithiocarbamate fungicide and the composition comprising acid-based pesticide and/or derivative thereof.

In some embodiments when components (1), (2) and (4) are combined before the addition of (3), mixing the three components (1), (2) and (4) prior to and/or during the addition of component-(3) is required.

In some embodiments, alkyl polyalkylene glycol ether phosphoric acid ester acid form is added to the combination prior to adding the composition comprising acid-based pesticide and/or derivative thereof.

In some embodiments, alkyl polyalkylene glycol ether phosphoric acid ester acid form is added in the process of preparing the combination, prior to adding the dithiocarbamate fungicide composition.

In some embodiments, when the composition comprising dithiocarbamate fungicide and the composition comprising acid-based pesticide and/or derivative thereof are mixed prior to adding the alkyl polyethylene glycol ether phosphoric acid ester acid form, mixing of the combination of composition comprising dithiocarbamate fungicide and the composition comprising acid-based pesticide and/or derivative thereof is required prior to adding and/or when the alkyl polyethylene glycol ether phosphoric acid ester acid form is added.

In some embodiments, dithiocarbamate fungicide is mancozeb.

In some embodiments, acid-based pesticide and/or derivative thereof is glyphosate potassium.

### Methods of Use

The invention also provides methods of treating a plant, or a part of a plant, against pest(s), comprising contacting the plant, part of the plant, locus of the pest, soil, and/or an area in which pest infestation is to be prevented with any one of the combinations and/or mixtures of compositions described herein.

Pest refers to weeds, pathogens and the like.

In some embodiments, treating comprises protecting the plant, or a part of the plant, against the pest.

In some embodiments, treating comprises preventing, reducing and/or eliminating the presence of a pest locus of the plant, on the plant, or a part of the plant.

In some embodiments, treating comprises controlling diseases caused by phytopathogenic fungi in the plant, or a part of the plant.

In some embodiments, treating comprises improving the control of the disease caused by phytopathogenic fungi in the plant, or a part of the plant.

The invention also provides a method of increasing crop yield comprising contacting the plant, part of the plant, locus of the pathogen, soil, and/or an area in which pest infestation is to be prevented with any one of the combinations.

The invention also provides a method of improving plant vigour comprising contacting the plant, part of the plant, locus of the pest, soil, and/or an area in which pest infestation is to be prevented with any one of the combinations.

The present invention also provides a method for pest control by preventive, curative or persistence treatments of a plant disease caused by pest comprising contacting a plant, a locus thereof or propagation material thereof with an effective amount of any one of the combinations disclosed herein.

The present invention also provides use of any one of the combinations described herein for treating a plant, or a part of a plant, against a pest.

The present invention also provides use of any one of the combinations described herein for increasing crop yield.

The present invention also provides use of any one of the combinations described herein for improving plant vigor.

In some embodiments, the combination is applied at an amount of 0.01-5 g/ha of the dithiocarbamate fungicide active ingredient(s). In some embodiments, the combination is applied at an amount of 0.01-3 g/ha of the dithiocarbamate fungicide active ingredient(s). In some embodiments, the combination is applied at an amount of 0.01-2 g/ha of the dithiocarbamate fungicide active ingredient(s). In some embodiments, the combination is applied at an amount of 0.01-1 g/ha of the dithiocarbamate fungicide active ingredient(s).

In some embodiments, the combination is applied at an amount of about 0.01-5 g/ha of mancozeb. In some embodiments, the combination is applied at an amount of about 0.01-3 g/ha of mancozeb. In some embodiments, the combination is applied at an amount of about 0.01-2 g/ha of mancozeb. In some embodiments, the combination is applied at an amount of about 0.01-1 g/ha of mancozeb. In some embodiments, the combination is applied at an amount of about 0.018 g/ha of mancozeb. In some embodiments, the combination is applied at an amount of about 0.97 g/ha of mancozeb. In some embodiments, the combination is applied at an amount of about 0.39 g/ha of mancozeb. In some embodiments, the combination is applied at an amount of about 1.56 g/ha of mancozeb. In some embodiments, the combination is applied at an amount of about 0.01-5 g/ha of glyphosate. In some embodiments, the combination is applied at an amount of about 0.01-3 g/ha of glyphosate. In some embodiments, the combination is applied at an amount of about 0.01-2 g/ha of glyphosate. In some embodiments, the combination is applied at an amount of about 0.01-1 g/ha of glyphosate. In some embodiments, the combination is applied at an amount of about 0.018 g/ha of glyphosate. In some embodiments, the combination is applied at an amount of about 0.97 g/ha of glyphosate. In some embodiments, the combination is applied at an amount of about 0.39 g/ha of glyphosate. In some embodiments, the combination is applied at an amount of about 1.56 g/ha of glyphosate.

A combination according to the invention is suitable for the control of pests that are encountered in horticulture, agriculture, and forestry. The combinations are active against normally sensitive and resistant pest species and during each, all, or individual stages of development.

In some embodiments, the combination is concentrated which intended to be diluted before application. To control agricultural pests, the invention provides a use of the combination, suspension and/or mixture according to the invention for the protection of a plant, or a part of a plant, against a pest. In order to achieve the desired effect, said plant or plant part, or a soil, is contacted with the suspension composition. Said combination, suspension and/or mixture is used, for example, to control powdery mildew and downy mildew infections on food/feed crops, including tree fruits, vegetable crops, field crops, grapes, ornamental plants, and sod farms. Further use of the combination, suspension and/or mixture according to the invention, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said suspension, may be contacted with isolated fruits, nuts, vegetables, and/or flowers.

For said above uses and said methods, the combination, suspension and/or mixture, is applied by being sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with the combination, suspension and/or mixture of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating for example, by means of wax or electrostatically, and other techniques well known in the art. In addition, combination, suspension and/or mixture may be injected into the soil.

In some embodiments, the pathogen is phytopathogenic fungi.

In some embodiments, the fungus is any one, or all of Leaf Blotch of Wheat (Mycosphaerella graminicola; anamorph: Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Bect (Cercospora beticola), Early Blight of Tomato (Alternaria solani), and Net Blotch of Barley (Pyrenophora teres).

In some embodiments where the pest is a weed, the weed is any one or all of, Commelina spp., Elcusine indica (goosegrass), Conyza spp (horseweed), Ipomeas pp (Morningglory), Digitaria insularis (sourgrass), Amaranthus spp (Pigweed).

In some embodiments, the pesticide is applied at a rate effective for controlling a pest. In some embodiments, the pesticide is applied at a rate effective for preventing infestation or infection by the pest. In some embodiments, the pesticide is applied at a rate effective for curing or removing the infestation or infection by the pest.

In some embodiments, the combination or composition comprising the combination is sprayed over a plant or a part of a plant.

In some embodiments, the plant part is leaf, seed or/and fruit.

In some embodiments, the combination or composition is applied pre-emergence. In some embodiments, the combination or composition is applied post-emergence.

In some embodiments, the combination or composition thereof is applied as a foliar application. In some embodiments, the combination or composition thereof is applied as a soil application.

In some embodiments, the combination or composition thereof is tank mixed with an additional agrochemical. In some embodiments, the combination or composition is applied sequentially with the additional agrochemical.

In some embodiments, the combination, suspension and/or mixture is tank mixed with an additional adjuvant. In some embodiments, the combination, suspension and/or mixture is applied sequentially, separately, or simultaneously with additional adjuvant.

In some embodiments, the adjuvant is selected from a group comprising plant oil derivatives. In some embodiments, the plant oil derivative is a vegetable oil derivative or often, esters thereof. In some embodiments, the vegetable oil derivative is a soybean oil methyl ester.

### Package and Kit

The present invention provides a package comprising any one of the combinations described herein or a kit of the components to prepare them.

The present invention also provides a package comprising (1) at least one dithiocarbamate fungicide, (2) at least one acid-based pesticide and/or derivative thereof and (3) at least one alkyl polyalkylene glycol ether phosphoric acid ester acid form.

The present invention also provides a package comprising (i) at least one alkyl polyalkylene glycol ether phosphoric acid ester acid form and (ii) (1) at least one composition comprising at least one dithiocarbamate fungicide and/or (2) at least one composition comprising at least one acid-based pesticide and/or derivative thereof.

Each embodiment disclosed herein is contemplated as being applicable to each of the other disclosed embodiments. Thus, all combinations of the various elements described herein are within the scope of the invention. In addition, the elements recited in combination embodiments can be used in the concentrate, suspension, method, use, process and package embodiments described herein and vice versa.

In addition, when lists are provided in this disclosure, the list is to be considered as a disclosure of each one member of the list individually and independently of the other members of that list.

A model dithiocarbamate composition chosen in some cases to demonstrate the efficacy of the compatibility agent was a combination suspension concentrate of Mancozeb, Picoxystrobin and Tebuconazole, and the model for the acid-based pesticide composition was Glyphosate SL. These compositions are normally so incompatible as to provide a demonstration that is evidence of stabilization over a wide range of dithiocarbamate and acid-based pesticide combined dispersions with the claimed compatibility agents.

This invention will be better understood by reference to the Experimental Details which follow, but those skilled in the art will readily appreciate that the specific experiments detailed are only illustrative of exemplary parts of the scope of the invention as described more fully in the claims which follow thereafter and the experiments described are not intended to define or limit the breadth of scope of the invention.

The invention is illustrated by the following examples without limiting its scope thereby.

### Experimental Section

### First Experimental Batch of Examples

Four compositions of mancozeb, as described in Indian Provisional Application No. 202011052575, (tables 1-4) were mixed with glyphosate composition to form the invention combinations.

### Method and Materials

Pesticidal composition of anionic pesticide: Roundup (Glyphosate K 540 SL), comprising 540 g/L glyphosate, present as the potassium salt.

### Mancozeb Compositions:

TABLE 1
Composition 1. SC Composition of Mancozeb and Prothioconazole

| Ingredient | g/L | % w/w |
|---|---|---|
| Mancozeb (as 87%) | 459.8 | 35.92 |
| Prothioconazole (As 99.6%) | 32.3 | 2.52 |
| Chitosan | 6.5 | 0.51 |
| Ecosurf EH-3 | 1.78 | 0.14 |
| Reax 88 A | 66.3 | 5.2 |
| Acetic acid | 3.0 | 0.23 |
| Sag 1572 | 5.8 | 0.45 |
| Propylene glycol | 47.3 | 3.70 |
| Proxel GXL | 0.87 | 0.07 |
| Methyl soyate | 25.6 | 2.0 |
| Supragil WP | 1.8 | 0.14 |
| AgRH 23 (2% solution) | 32.5 | 2.5 |
| Water | 596.5 | 46.6 |
| Total: | 1280 | 100 |

TABLE 2
Composition 2, SE composition of Mancozeb,
Prothioconazole and Picoxystrobin

| Ingredients | % w/w |
|---|---|
| Water | 33.49 |
| Prothioconazole (99.7@3.02%) | 3.03 |
| Picoxystrobin (99.9@2.31%) | 2.31 |
| Solvesso200 | 9.00 |
| Rhodiasolv Match 111 | 2.50 |
| Emulsogen TS-100 | 0.50 |
| SAG 1572 | 0.40 |
| Chitosan | 0.50 |
| Propylene glycol | 4.00 |
| Acetic acid | 0.30 |
| Mancozeb (85.8% @ 31.65) | 36.89 |
| Reax 88B | 6.00 |
| Proxel GXL | 0.08 |
| AgRH 23 (2%) | 1.00 |
| Total | 100.00 |

TABLE 3
Composition 3, SC Composition of Mancozeb,
Tebuconazole and Picoxystrobin

| Ingredient | g/L | % w/w |
|---|---|---|
| Tap water | 601.8 | 46.3% |
| Propylene glycol | 42.6 | 3.3% |
| Chitosan | 5.1 | 0.4% |
| Acetic acid (Galcial) | 3.0 | 0.2% |
| Triton HW-1000 | 1.0 | 0.1% |
| Mancozeb (86.1%-500 g/L) | 464.6 | 35.8% |
| Silcolapse 432 | 0.9 | 0.07% |
| Reax 88-A | 72.6 | 5.6% |
| SAG 1572 | 4.1 | 0.32% |
| Methyl soyate | 20.3 | 1.6% |
| Stepwet DF-95 | 1.2 | 0.1% |
| Tebuconazole 98% | 33.4 | 2.6% |
| Picoxystrobin 99% | 26.6 | 2.0% |
| acticide MBS | 0.84 | 0.06% |
| AgRH 23 (2% solution) | 22 | 1.7% |
| Total | 1300.0 | 100.0% |

TABLE 4
Composition 4, SC Composition of Mancozeb,
Prothioconazole and Picoxystrobin

| Ingredient | g/L | % w/w |
|---|---|---|
| Mancozeb (as 87%) | 459.8 | 35.4 |
| Prothioconazole (as 99.6%) | 38.2 | 2.97 |
| Picoxystrobin (as 99%) | 29.3 | 2.28 |
| Chitosan | 6.5 | 0.52 |
| Ecosurf EH-3 | 2.0 | 0.14 |
| Reax 88 A | 68.9 | 5.3 |
| Acetic acid | 3.0 | 0.23 |
| Sag 1572 | 5.1 | 0.39 |
| Propylene glycol | 47.8 | 3.68 |
| Proxel GXL | 0.87 | 0.07 |
| Methyl soyate | 26.5 | 2.04 |
| Supragil WP | 2.0 | 0.15 |
| AgRH 23 (2% solution) | 32.5 | 2.5 |
| Water | 577.5 | 44.43 |
| Total: | 1300 | 100 |

### Methods:

### Compatibility of Mancozeb and Glyphosate.

### Test 1: Phase Separation/Sedimentation.

Compatibility of the mancozeb compositions and the pesticide salt composition is measured as volume percentage of phase separation and/or sediment.

A compatible result is when the sediment volume is equal or less than 2%.

### Examples 1-4: Composition of Mancozeb (Table 1-4), Glyphosate with and without Hostaphat 1306

Comparative Tests (1a-4a) without Hostaphat® 1306.

In a 100 mL measuring cylinder, 2 gr of mancozeb composition (1-4) and 2 gr of herbicide composition (Glyphosate K 540 SL) were added to 96 gr of water (Standard water D). The cylinder was inverted 10 times between additions and inverted an additional 10 times after all components were incorporated and then transferred to a conical cylinder. It was left to stand undisturbed for 30 min, and sedimentation volumes were recorded after 10 min and 30 min.

Tests (1b-4b)—with Hostaphat 1306

In a 100 mL measuring cylinder, 0.5 gr of Hostaphat® 1306, 2 gr of mancozeb composition (1-4) and 2 gr of herbicide composition (Glyphosate K 540 SL) were added to 95.5 gr of water (Standard water D). The cylinder was inverted 10 times between additions and inverted an additional 10 times after all components were incorporated and then transferred to a conical cylinder. It was left to stand undisturbed for 30 min, and sedimentation volumes were recorded after 10 min and 30 min

Results are described in table 5.

TABLE 5

| | | | Dispersion | | Dispersion | |
|---|---|---|---|---|---|---|
| | | % | stability | | stability | |
| | | form. | 10 min | | 30 min | |
| | Composition 1 | | | | | |
| 1a | Mancozeb 400 Prothiocnazole 32 SC | 2 | 9 | ml sedimen | | |
| | Glyphosate 540 SL | 2 | | | | |
| 1b | Mancozeb 400 Prothiocnazole 32 SC | 2 | 0.15 | ml sedimen | 0.2 | ml sedimen |
| | Glyphosate 540 SL | 2 | | | | |
| | Hostaphat 1306 | 0.5 | | | | |
| | Composition 2 | | | | | |
| 2a | Mancozeb 400 Prothiocnazole 38 Picoxystrobin 29 SE | 2 | 10 | ml sedimen | | |
| | Glyphosate 540 SL | 2 | | | | |
| 2b | Mancozeb 400 Prothiocnazole 38 Picoxystrobin 29 SE | 2 | 0.1 | ml sedimen | 0.2 | ml sedimen |
| | Glyphosate 540 SL | 2 | | | | |
| | Hostaphat 1306 | 0.5 | | | | |
| | Composition 3 | | | | | |
| 3a | Mancozeb 400 Tebuconazole 32.6 Picoxystrobin 26.3 SC | 2 | 10 | ml sedimen | | |
| | Glyphosate 540 SL | 2 | | | | |
| 3b | Mancozeb 400 Tebuconazole 32.6 Picoxystrobin 26.3 SC | 2 | 0.25 | ml sedimen | 0.25 | ml sedimen |
| | Glyphosate 540 SL | 2 | | | | |
| | Hostaphat 1306 | 0.5 | | | | |
| | Composition 4 | | | | | |
| 4a | Mancozeb 400 Prothiocnazole 38 Picoxystrobin 29 SC | 2 | 10 | ml sedimen | | |
| | Glyphosate 540 SL | 2 | | | | |
| 4b | Mancozeb 400 Prothiocnazole 38 Picoxystrobin 29 SC | 2 | 0.2 | ml sedimen | 0.2 | ml sedimen |
| | Glyphosate 540 SL | 2 | | | | |
| | Hostaphat 1306 | 0.5 | | | | |

### Examples 5-6: Phase Separation/Sedimentation Tests with and without Agrilan 1028 or SERVOXYL® VPDZ 3/100

Comparative Test without Agrilan 1028 or SERVOXYL® VPDZ 3/100:

In a 100 mL measuring cylinder, 2 gr of mancozeb composition (composition 3) and 2 gr of herbicide composition (Glyphosate K 540 SL) were added to 96 gr of water (Standard water D). The cylinder was inverted 10 times between additions and inverted an additional 10 times after all components were incorporated and then transferred to a conical cylinder. It was left to stand undisturbed for 30 min, and sedimentation volumes were recorded after 10 min and 30 min.

Test with Agrilan 1028 or SERVOXYL® VPDZ 3/100

In a 100 mL measuring cylinder, 0.5 gr of Agrilan 1028 or SERVOXYL® VPDZ 3/100, 2 gr of mancozeb composition (composition 3) and 2 gr of herbicide composition (Glyphosate K 540 SL) were added to 95.5 gr of water (Standard water D). The cylinder was inverted 10 times between additions and inverted an additional 10 times after all components were incorporated and then transferred to a conical cylinder. It was left to stand undisturbed for 30 min, and sedimentation volumes were recorded after 10 min and 30 min in a 100 mL measuring cylinder. The results showed less than 2 ml of sedimentation.

### Test 2-Sieve Test

### Example 7

### Compatibility of Composition 1 and Glyphosate in the Presence of Hostaphat 1306.

In a 100 mL measuring cylinder, 0.5 gr of Hostaphat 1306, 2 gr of mancozeb composition (composition 1) and 2 gr of herbicide composition (Glyphosate K 540 SL) were added to 95.5 gr of water (Standard water D). The cylinder was inverted 10 times between additions and inverted an additional 10 times after all components were incorporated, and then transferred to a conical cylinder. Left to stand undisturbed for 30 min. At the end of this period, re-dispersion was performed by 10 inversions of the cylinder and the contents were screened through a 25 μm (500 mesh BSS) screen. Washing of the material was done with a jet of tap water.

Comparative Test (without Hostaphat 1306):

In a 100 mL measuring cylinder, 2 gr of mancozeb composition (composition 1) and 2 gr of herbicide composition (Glyphosate K 540 SL) were added to 96 gr of water (Standard water D). The cylinder was inverted 10 times between additions and inverted an additional 10 times after all components were incorporated, and then transferred to a conical cylinder. Left to stand undisturbed for 30 min. At the end of this period, re-dispersion was performed by 10 inversions of the cylinder and the contents were screened through a 25 μm (500 mesh BSS) screen. Washing of the material was done with a jet of tap water.

Results were observed by visual appearance of residue material on the sieve.
With the Hostaphat 1306 a significant reduction in the amount of residue material was observed in compared to the test without the Hostaphat 1306.

### Second Experimental Batch of Examples

The following compositions, exemplifying tank-mixes, were prepared by adding each ingredient to a 100 ml cylinder with water and analyzed as summarized in the tables below. All compositions exemplifying tank mixes were prepared with “Standard Water D”, 342 ppm Hardness, pH 6.0-7.0, Working Solution according to CIPAC.

The model dithiocarbamate composition chosen to demonstrate the efficacy of the compatibility agent was a combination suspension concentrate of Mancozeb, Picoxystrobin and Tebuconazole, and the model for the acid-based pesticide composition was Glyphosate SL. These compositions are normally so incompatible as to provide a demonstration that is evidence of stabilization over a wide range of dithiocarbamate and acid-based pesticide combined dispersions. Ten inversions of the cylinder were conducted between each ingredient addition. Dispersion stability was checked after 10 min and after 30 min.
Comparing Compositions with and without Rhodafac® PA 23

| | | Sequence of | Sequence of |
|---|---|---|---|
| Composition | % | Addition | Addition |
| Mancozeb 400 + Picoxy 26 + | 2 | 3 | 2 |
| Tebuconazole 32.5 SC | | | |
| Glyphosate 540 SL | 2 | 2 | 1 |
| Rhodafac ® PA 23 | 0.5 | 1 | 0 |

| | | |
|---|---|---|
| Dispersion stability 10 min | 0.15 | complete |
| | | separation |
| Dispersion stability 30 min | 0.25 | complete |
| | | separation |

### Use of Crodafos® 810A

| | | Sequence of |
|---|---|---|
| Composition | % | Addition |
| Mancozeb 400 + Picoxy 26 + | 2 | 3 |
| Tebuconazole 32.5 SC | | |
| Glyphosate 540 SL | 2 | 2 |
| Crodafos ® 810A | 0.5 | 1 |

| | |
|---|---|
| Dispersion stability 10 min | 0.15 some clouds - |
| | less homogeneous |
| Dispersion stability 30 min | 0.75 some clouds - |
| | less homogeneous |

Comparative Example with Soprophor® 3D 33

| | | Sequence of |
|---|---|---|
| Composition | % | Addition |
| Mancozeb 400 + Picoxy 26 + | 2 | 3 |
| Tebuconazole 32.5 SC | | |
| Glyphosate 540 SL | 2 | 2 |
| Soprophor ® 3D 33 | 0.5 | 1 |

| | |
|---|---|
| Dispersion stability 10 min | complete separation |
| Dispersion stability 30 min | complete separation |

Comparative Example with Soprophor® 4D384

| | | Sequence of |
|---|---|---|
| Composition | % | Addition |
| Mancozeb 400 + Picoxy 26 + | 2 | 3 |
| Tebuconazole 32.5 SC | | |
| Glyphosate 540 SL | 2 | 2 |
| Soprophor ® 4D384 | 0.5 | 1 |

| | |
|---|---|
| Dispersion stability 10 min | complete separation |
| Dispersion stability 30 min | complete separation |

Crodafos 810A and Rhodafac PA 23 are shown to be useful examples of compatibility agents. Both helped significantly as compatibility agents while Rhodafac PA 23 was shown to be preferred.

In comparison, Soprophor® 3D 33 and Soprophor® 4D384 were also tested as compatibility agents for combination of Mancozeb 400+Picoxy 26+Tebuconazole 32.5 SC and Glyphosate 540 SL, However neither were found to be useful compatibility agents in these combination dispersions as complete separation was observed.

It is worthwhile noting that when the compatibility of Mancozeb 400/Picoxystrobin 26/Tebuconazole 32.5 SC was tested with Azoxystrobin 250 SC (Mirador Plus®) and with 2,4 D ester, both combinations were found to be compatible.

What is claimed is:

1. A stable combined dispersion of at least one dithiocarbamate fungicide and at least one acid-based pesticide or derivative thereof, and/or derivative thereof in a liquid carrier, wherein said dispersion is stabilized by inclusion of at least one organic phosphoric acid ester-based compatibility agent and wherein said dispersion is characterized by an improvement in the stability, compatibility, and suspensibility of the dispersion defined by either or both,
a. a reduction in the rate and/or extent of phase separation and/or sedimentation as compared with a combined dispersion of the same amount of the same dithiocarbamate fungicide and the same amount of the same acid-based pesticide in the absence of the compatibility agent, over comparable periods of time, or
b. the sediment volume is equal or less than 2% of the volume of the combined dispersion when left to stand undisturbed for a period of 10, preferably 30 minutes.

2. The stable combined dispersion as claimed in claim 1 wherein the acid-based pesticide is in salt form; in some embodiments, acid-based herbicide includes but is not limited to glyphosate salt, glufosinate salt, bispyribac salt and 2,4 D salt.

3. The stable combined dispersion as claimed in claim 2 wherein the acid-based pesticide is in the form of agriculturally acceptable alkali metal salts, alkaline earth metal salts and/or ammonium salts.

4. The stable combined dispersion as claimed in any one of claims 1-3 wherein the acid-based pesticide is one or more of glyphosate salt, glufosinate salt, bispyribac salt and 2,4 D salt.

5. The stable combined dispersion as claimed in any one of claims 1-4 wherein the acid-based pesticide agriculturally acceptable salt is an alkali or alkaline earth metal salt selected from sodium; potassium; lithium, magnesium, and calcium; a salt metals selected from copper; iron; zinc; cobalt; and nickel, or the salt contains an ammonium group.

6. The stable combined dispersion as claimed in any one of claims 1-5 wherein, the acid-based pesticide is an acid-based herbicide selected from glyphosate sodium; glyphosate potassium; glyphosate ammonium and glufosinate-potassium.

7. The stable combined dispersion as claimed in claim 1, wherein the liquid carrier comprises water.

8. The stable combined dispersion as claimed in any one of claims 1-2 wherein the at least one organic phosphoric acid ester-based compatibility agent is selected from the group of,
a. mono-esters of phosphoric acid;
b. diesters of phosphoric acid;
c. triesters of phosphoric acid;
d. phosphoric acid decyl octyl ester;
e. phosphate esters of alcohol ethoxylates;
f. alkoxylated phosphoric acid mono-esters;
g. alkoxylated phosphoric acid di-esters;
h. alkoxylated phosphoric acid tri-esters;
i. alkoxylated polyarylphenol di- and tri-phosphate esters;
j. alkyl alkoxylated phosphoric acid mono-esters;
k. alkyl alkoxylated phosphoric acid di-esters;
l. tristyrylphenol ethoxylate phosphate di-ester;
m. tristyrylphenol ethoxylate phosphate tri-ester;
n. styryl substituted ethoxylated and phosphorylated phenols;
o. phosphorylated, ethoxylated fatty alcohols
p. phosphorylated, propoxylated fatty alcohols
q. phosphorylated ethylene oxide/propylene oxide block polymers;
r. alkyl polyalkylene glycol ether phosphoric acid ester acid form; and
s. salts and/or mixtures thereof.

9. The stable combined dispersion as claimed in any one of claims 1-8 wherein the dispersion is a combined tank mix suspension in water.

10. A combination of (1) at least one dithiocarbamate fungicide, (2) at least one acid-based pesticide and (3) at least one alkyl polyalkylene glycol ether phosphoric acid ester acid form.

11. A combination of (1) at least one dithiocarbamate fungicide, (2) at least one acid-based pesticide and/or derivative thereof, (3) at least one alkyl polyalkylene glycol ether phosphoric acid ester acid form, and (4) water.

12. A combination comprising (1) at least one dithiocarbamate fungicide (2) at least one acid-based pesticide in salt form (3) at least one alkyl polyalkylene glycol ether phosphoric acid ester acid form and optionally, (4) one or more additional pesticides.

13. The combination of any one of claims 10-12, wherein the combination further comprises water.

14. The stable combined dispersion as claimed in claim 1 or the combination of any one of claims 10-13, wherein the acid-based pesticide is carboxylic acid and/or sulphate pesticide and/or a phosphate and/or a phosphonate pesticide.

15. The stable combined dispersion as claimed in claim 1 or the combination of any one of claims 10-13, wherein the acid-based pesticide is herbicide.

16. The combination of any one of claims 10-15, wherein the acid-based pesticide is in the acid form.

17. The combination of any one of claims 10-13, wherein the acid-based pesticide is in the salt form.

18. The combination of any one of claims 10-15, wherein the acid-based pesticide is in the ester form.

19. The combination of claim 17, wherein the acid-based pesticide is in salt form in the form of alkali metal salts, alkaline earth metal salts and/or ammonium salts.

20. The combination of any one of claims 10-14, wherein the alkyl polyalkylene glycol ether phosphoric acid ester acid form is either or both of the acid form and the salt form thereof.

21. The combination of any one of claims 10-20, wherein the combination further comprises at least one additional pesticide which is different from acid-based pesticide (2).

22. A combination comprising (1) at least one dithiocarbamate fungicide (2) at least one acid-based pesticide in salt form (3) at least one alkyl polyalkylene glycol ether phosphoric acid ester acid form and optionally, (4) one or more additional pesticide.

23. A combination comprising (1) an amount of at least one dithiocarbamate fungicide (2) an amount of at least one acid-based pesticide in salt form (3) an amount of at least one alkyl polyalkylene glycol ether phosphoric acid ester acid form (4) water, and optionally (5) at least one additional pesticide.

24. The combination of any one of claims 10-23, wherein the combination is an aqueous suspension.

25. The combination of any one of claims 10-24 wherein the dithiocarbamate fungicide is a composition which comprises dithiocarbamate fungicide active ingredient.

26. The combination of any one of claims 10-25, wherein the acid-based pesticide is a composition which comprises acid-based pesticide active ingredient.

27. The combination of any one of claims 10-26, wherein the alkyl polyalkylene glycol ether phosphoric acid ester acid form and the dithiocarbamate fungicide are formulated together in a composition.

28. The combination of any one of claims 10-26, wherein the alkyl polyalkylene glycol ether phosphoric acid ester acid form and the at least one acid-based pesticide are formulated together in a composition.

29. The stable combined dispersion as claimed in any one of claims 1-9 or the combination of any one of claims 10-28, wherein the weight ratio between the organic phosphoric acid ester-based compatibility agent or the alkyl polyalkylene glycol ether phosphoric acid ester acid form and acid-based herbicide is from about 1:1 to about 1:4.

30. The stable combined dispersion as claimed in any one of claims 1-9 or the combination of any one of claims 10-28, wherein the weight ratio between the organic phosphoric acid ester-based compatibility agent or the alkyl polyalkylene glycol ether phosphoric acid ester acid form and acid-based herbicide is about 1:2.

31. The stable combined dispersion as claimed in any one of claims 1-9 or the combination of any one of claims 10-28, wherein the weight ratio between the organic phosphoric acid ester-based compatibility agent or the alkyl polyalkylene glycol ether phosphoric acid ester acid form and dithiocarbamate fungicide is from about 1:1 to about 1:4.

32. The stable combined dispersion as claimed in any one of claims 1-9 or the combination of any one of claims 10-28, wherein the weight ratio between the organic phosphoric acid ester-based compatibility agent or the alkyl polyalkylene glycol ether phosphoric acid ester acid form and the dithiocarbamate fungicide is about 1:2.

33. The stable combined dispersion as claimed in any one of claims 1-9 or the combination of any one of claims 10-29, wherein the weight ratio between the organic phosphoric acid ester-based compatibility agent or the alkyl polyalkylene glycol ether phosphoric acid ester acid form and the dithiocarbamate fungicide is about 1:1.6.

34. The stable combined dispersion as claimed in any one of claims 1-9 or the combination of any one of claims 10-33, wherein the dithiocarbamate fungicide is mancozeb.

35. The stable combined dispersion as claimed in any one of claims 1-9 or the combination of any one of claims 10-34, wherein the organic phosphoric acid ester-based compatibility agent or the alkyl polyalkylene glycol ether phosphoric acid ester acid form is an alkyl polyethylene glycol ether phosphoric acid mono/diester (50/50), acid form.

36. The stable combined dispersion as claimed in any one of claims 1-9 or the combination of any one of claims 10-34, wherein the organic phosphoric acid ester-based compatibility agent or the alkyl polyalkylene glycol ether phosphoric acid ester acid form is isotridecyl polyoxethyl (6 EO) phosphoric acid mono/diester, ca. 96% liquid acid form (Hostaphat® 1306).

37. The stable combined dispersion as claimed in any one of claims 1-9 or the combination of any one of claims 10-34, wherein the acid-based pesticide is a herbicide.

38. The stable combined dispersion or the combination of claim 37, wherein the herbicide is potassium glyphosate.

39. A process for preparing a suspension comprising mixing (1) at least one dithiocarbamate fungicide, (2) at least one acid-based pesticide and/or derivative thereof, (3) at least one alkyl polyalkylene glycol ether phosphoric acid ester acid form and (4) water.

40. A suspension prepared by the process of claim 39.

41. A package comprising (1) at least one dithiocarbamate fungicide, (2) at least one acid-based pesticide and/or derivative thereof and (3) at least one alkyl polyalkylene glycol ether phosphoric acid ester acid form.

42. A package comprising (i) at least one alkyl polyalkylene glycol ether phosphoric acid ester acid form and (ii) (1) at least one composition comprising at least one dithiocarbamate fungicide and/or (2) at least one composition comprising at least one acid-based pesticide and/or derivative thereof.

43. A kit for preparing a combination comprising (i) at least one alkyl polyalkylene glycol ether phosphoric acid ester acid form and (ii) (1) at least one composition comprising at least one dithiocarbamate fungicide and (2) at least one composition comprising at least one acid-based pesticide and/or derivative thereof.

44. Use of at least one alkyl polyalkylene glycol ether phosphoric acid ester acid form for dispersing at least one dithiocarbamate fungicide and at least one acid-based pesticide and/or derivative thereof into a stable combined dispersion in a liquid carrier.

45. Use of at least one alkyl polyalkylene glycol ether phosphoric acid ester acid form for reducing the rate and/or extent of phase separation and/or sedimentation of an aqueous suspension comprising (1) at least one dithiocarbamate fungicide and (2) at least one acid-based pesticide, wherein the rate and/or extent of phase separation and/or sedimentation of the suspension is lower than the rate and/or extent of phase separation and/or sedimentation of a comparable aqueous suspension when the at least one dithiocarbamate fungicide and the at least one acid-based pesticide are combined in the absence of said alkyl polyalkylene glycol ether phosphoric acid ester acid form over comparable time periods.

46. A method of treating a plant, or a part of a plant, against pest(s), comprising contacting the plant, part of the plant, locus of the pest, soil, and/or an area in which pest infestation is to be prevented with any one of the stable combined dispersions as claimed in any one of claims 1-9 or the combinations claimed in any one of claims 10-38 and/or claim 40.

47. A mixture of mancozeb, prothioconazole and glyphosate.

48. A mixture of mancozeb, prothioconazole, picoxystrobin and glyphosate.

49. A method for use in identifying an acceptable organic phosphoric acid ester-based compatibility agent capable of reducing the rate and/or extent of phase separation and/or sedimentation of an aqueous dispersion comprising a dithiocarbamate fungicide and an acid-based pesticide or salt thereof, the protocol comprising the steps of combining the compatibility agent candidate, the dithiocarbamate fungicide and the acid-based pesticide or salt thereof and water as a dispersion in a container, optionally inverting the container between addition of each component and again after all components are incorporated, allowing the dispersion to stand undisturbed for a period of time, and recording the sedimentation volume after 10 minutes, wherein when the sediment volume is equal or less than 2% of the volume of the dispersion an acceptable compatibility agent is identified.

50. A stable aqueous dispersion comprising mancozeb, and glyphosate salt, with reduced sedimentation volume characterized in that the sediment volume is equal or less than 2% of the dispersion volume on standing undisturbed for no less than 10 minutes, wherein the dispersion comprises a compatibility agent identified by the method as claimed in claim 49.

51. A stable aqueous dispersion comprising mancozeb, prothioconazole and glyphosate salt, with reduced sedimentation volume characterized in that the sediment volume is equal or less than 2% of the dispersion volume on standing undisturbed for no less than 10 minutes, wherein the dispersion comprises a compatibility agent identified by the method as claimed in claim 49.

52. A stable aqueous dispersion comprising mancozeb, prothioconazole, picoxystrobin and glyphosate salt, with reduced sedimentation volume characterized in that the sediment volume is equal or less than 2% of the dispersion volume on standing undisturbed for no less than 10 minutes, wherein the dispersion comprises a compatibility agent identified by the method as claimed in claim 49.

53. A stable aqueous dispersion comprising mancozeb, Tebuconazole, picoxystrobin and glyphosate salt, with reduced sedimentation volume characterized in that the sediment volume is equal or less than 2% of the dispersion volume on standing undisturbed for no less than 10 minutes, wherein the dispersion comprises a compatibility agent identified by the method as claimed in claim 49.

54. The stable aqueous dispersion as claimed in any one of claims 50-53 characterized in that the sediment volume is equal or less than 2% of the dispersion volume on standing undisturbed for no less than 30 minutes.

55. The stable aqueous dispersion as claimed in any one of claims 50-53 characterized in that the sediment volume is equal or less than 2% of the dispersion volume on standing undisturbed for no less than 30 minutes.

56. The combinations claimed in any one of claims 10-38 and/or claim 40 characterized in that the sediment volume is equal or less than 2% of the dispersion volume on standing undisturbed for no less than 10 minutes.

57. The stable combined dispersions as claimed in any one of claims 1-9 or the combinations claimed in any one of claims 10-38 and/or claim 40 characterized in that the sediment volume is equal or less than 2% of the dispersion or combination volume on standing undisturbed for no less than 30 minutes.
